(19) United States
(12) Patent Application Publication
(10) Pub. No.: US 2005/0190171 A1
(43) Pub. Date: Sep. 1, 2005

(54) Display device and device of driving light source therefor

(76) Inventors: Hyeon-Yong Jang, Osan-si (KR); Nam-Ok Kwon, Seoul (KR); Min-Gyu Kim, Seoul (KR)

Correspondence Address: CANTOR COLBURN, LLP, 55 GRIFFIN ROAD SOUTH, BLOOMFIELD, CT, 06002, US

(21) Appl. No.: 11/016,799

(22) Filed: Dec. 20, 2004

(30) Foreign Application Priority Data
Dec. 19, 2003 (KR) 10-2003-0093842

(51) Int. Cl. G09G 3/36; G09G 5/00

(52) U.S. Cl. 345/204; 345/102

(57) ABSTRACT

A device of driving a light source for a display device is provided, which includes: a temperature sensor detecting a temperature near the light source; and an inverter controlling the light source depending on temperature information supplied from the temperature sensor. The inverter adjusts either or both of a driving frequency and a driving current of the light source depending on the temperature information. The inverter decreases the driving frequency when the detected temperature is lower than a first temperature, and the inverter increases the driving current when the detected temperature is lower than a second temperature lower than the first temperature.

### BACKGROUND OF THE INVENTION

(a) Field of the Invention

The present invention relates to a liquid crystal display and a device of driving a light source therefor.

(b) Description of Related Art

Display devices used for monitors of computers and television sets generally include self-emitting display devices such as organic light emitting displays (OLEDs), vacuum fluorescent displays (VFDs), field emission displays (FEDs), and plasma panel displays (PDPs), and non-emitting display devices such as liquid crystal displays (LCDs) requiring external light source.

An LCD includes two panels provided with field-generating electrodes and a liquid crystal (LC) layer having dielectric anisotropy and interposed therebetween. The field-generating electrodes that are supplied with electric voltages generate electric field across the LC layer, and the light transmittance of the liquid crystal layer varies depending on the strength of the applied field, which can be controlled by the applied voltages. Accordingly, desired images are displayed by adjusting the applied voltages.

The light for an LCD is provided by lamps equipped at the LCD or may be a natural light. When employing the lamps, the brightness on a screen of the LCD is usually adjusted by regulating the ratio of on and off durations of the lamps or regulating the current flowing in the lamps.

The lamps for the LCDs usually include fluorescent lamps driven by an inverter. The inverter converts DC voltage into AC voltage and applies the AC voltage to the lamps to be turned on. The inverter adjusts luminance of the lamps according to a luminance control signal to control the luminance of the LCD. In addition, the inverter feedback controls the voltages applied to the lamps based on the currents of the lamps.

A fluorescent lamp such as a cold cathode fluorescent lamp (CCFL) usually includes a hot terminal supplied with AC voltage and a cold terminal connected to a ground. However, this configuration may yield the difference in the luminance between the hot terminal and the cold terminal. Therefore, it is suggested a differential driving that AV voltage is applied across the lamp, that is, both terminals of the lamp are supplied with AC voltage, but having opposite phases.

However, the differential driving may make a mid-portion of the lamp between the two terminals be grounded to yield large current leakage such that the mid-portion of the lamp is darker than other portions particularly under a low temperature. In addition, it is hard to detect the current at the mid-portion of the lamp.

### SUMMARY OF THE INVENTION

A device of driving a light source for a display device is provided, which includes: a temperature sensor detecting a temperature near the light source; and an inverter controlling the light source depending on temperature information supplied from the temperature sensor.

The inverter may adjust either or both of a driving frequency and a driving current of the light source depending on the temperature information.

The inverter may decrease the driving frequency when the detected temperature is lower than a first temperature, and the inverter may increase the driving current when the detected temperature is lower than a second temperature lower than the first temperature.

The light source may include a lamp having two opposite ends supplied with AC voltage.

The temperature sensor may include: a temperature sensing unit outputting a voltage having a magnitude varying dependent on a peripheral temperature; and a first comparator comparing the output voltage of the temperature sensing unit with a first reference voltage to generate a first comparison signal. The temperature sensor may further include a second comparator comparing the output voltage of the temperature sensing unit with a second reference voltage different from the first reference voltage to generate a second comparison signal. The temperature sensor may further include a signal addition and division unit dividing the first comparison signal to generate a first output signal and adding the first comparison signal and the second comparison signal to generate a second output signal, the first and the second output signal being provided as the temperature information for the inverter.

The signal addition and division unit temperature sensor may include: a first diode connected to the first comparator and having an output for the first output signal; a second diode connected to the first comparator in parallel to the first diode; and a third diode connected to the second comparator, wherein the second and the third diode have a common output for the second output signal.

The inverter may include: a signal generator generating a periodical signal having a frequency that varies depending on the first output signal supplied from the temperature sensor; a controller generating a DC driving signal based on the periodical signal supplied from the signal generator and the second output signal supplied from the temperature sensor; a switching unit converting the DC driving signal into an AC driving signal; and a transformer boosting up the AC driving signal and applying the boosted AC signal to the light source.

The device may further include a current sensor detecting a current flowing in the light source and supplying current information to the controller, wherein the controller adjusts the DC driving signal based on the current information.

The inverter may include: a signal generator generating a periodical signal having a frequency that varies depending on the temperature information; a controller generating a DC driving signal based on the periodical signal supplied from the signal generator and the temperature information; a switching unit converting the DC driving signal into an AC driving signal; and a transformer boosting up the AC driving signal and applying the boosted AC signal to the light source.

The signal generator may decrease the frequency of the periodical signal when the temperature information indicates that the detected temperature is lower than a first temperature.

The controller may increase the amplitude of the DC driving signal when the temperature information indicates that the detected temperatures is lower than a second temperature lower than the first temperature.

The device may further include a current sensor detecting a current flowing in the light source and supplying current information to the controller, wherein the controller adjusts the DC driving signal based on the current information.

A display device is provided, which includes: a display panel displaying images; a lamp supplying light to the display panel; a temperature sensor detecting a temperature near the lamp; and an inverter controlling the light source depending on temperature information supplied from the temperature sensor.

The inverter may decrease the driving frequency when the detected temperature is lower than a first temperature and increase the driving current when the detected temperature is lower than a second temperature lower than the first temperature.

The temperature sensor may include: a temperature sensing unit outputting a voltage having a magnitude varying dependent on a peripheral temperature; a first comparator comparing the output voltage of the temperature sensing unit with a first reference voltage to generate a first comparison signal; a second comparator comparing the output voltage of the temperature sensing unit with a second reference voltage different from the first reference voltage to generate a second comparison signal; and a signal addition and division unit dividing the first comparison signal to generate a first output signal and adding the first comparison signal and the second comparison signal to generate a second output signal, the first and the second output signal being provided as the temperature information for the inverter.

The inverter may include: a signal generator generating a periodical signal having a frequency that varies depending on the first output signal supplied from the temperature sensor; a controller generating a DC driving signal based on the periodical signal supplied from the signal generator and the second output signal supplied from the temperature sensor; a switching unit converting the DC driving signal into an AC driving signal; and a transformer boosting up the AC driving signal and applying the boosted AC signal to the lamp.

### BRIEF DESCRIPTION OF THE DRAWINGS

The present invention will become more apparent by describing preferred embodiments thereof in detail with reference to the accompanying drawings in which:

FIG. 1 is an exploded perspective view of an LCD according to an embodiment of the present invention;

FIG. 2 is a block diagram of a part of the LCD shown in FIG. 1;

FIG. 3 is an equivalent circuit diagram of a pixel of the LCD shown in FIG. 1;

FIG. 4 is a circuit diagram of a temperature sensor according to an embodiment of the present invention; and

FIGS. 5A and 5B are graphs illustrating current leakage depending on a driving frequency and a driving current, respectively.

### DETAILED DESCRIPTION OF EMBODIMENTS

The present invention now will be described more fully hereinafter with reference to the accompanying drawings, in which embodiments of the inventions invention are shown.

In the drawings, the thickness of layers and regions are exaggerated for clarity. Like numerals refer to like elements throughout. It will be understood that when an element such as a layer, film, region, substrate or panel is referred to as being “on” another element, it can be directly on the other element or intervening elements may also be present. In contrast, when an element is referred to as being “directly on” another element, there are no intervening elements present.

Then, a liquid crystal display as an example of a display device and a device and method of driving a light source for a liquid crystal display according to embodiments of the present invention will be described with reference to the accompanying drawings.

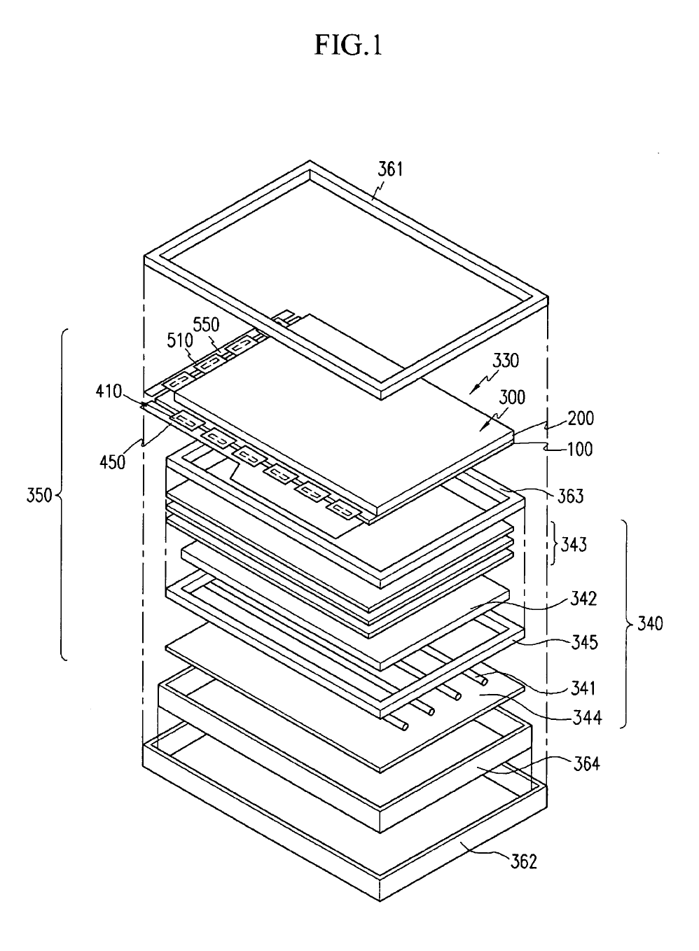

A liquid crystal display according to an embodiment of the present invention is described in detail with reference to FIGS. 1-3.

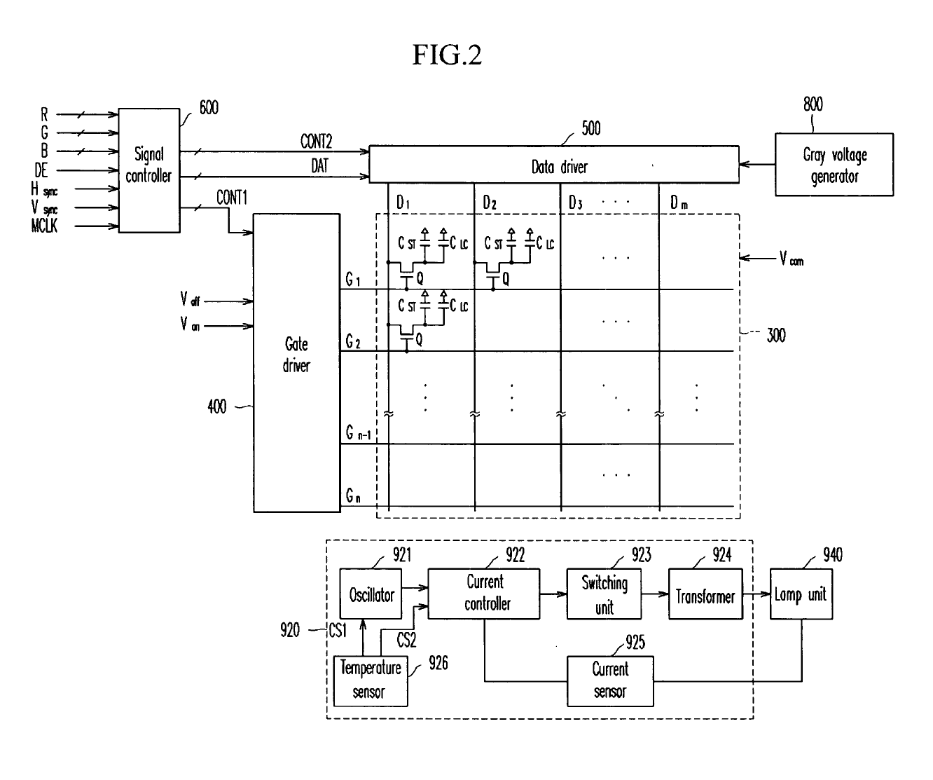

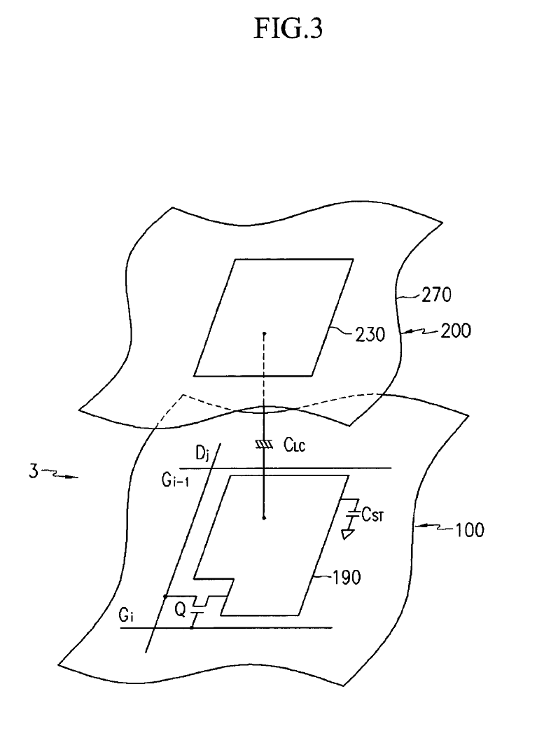

FIG. 1 is an exploded perspective view of an LCD according to an embodiment of the present invention, FIG. 2 is a block diagram of a part of the LCD shown in FIG. 1, and FIG. 3 is an equivalent circuit diagram of a pixel of the LCD shown in FIG. 1.

Referring to FIG. 1, an LCD according to an embodiment of the present invention includes a display module 350 including a display unit 330 and a backlight unit 340, and a pair of front and rear chassis 361 and 362, and a mold frame 364 containing and fixing the LC module 350.

The display unit 330 includes a display panel assembly 300, a plurality of gate tape carrier packages (TCPs) or chip-on-film (COF) type packages 410 and a plurality of data TCPs 510 attached to the display panel assembly 300, and a gate printed circuit board (PCB) 450 and a data PCB 550 attached to the gate and the data TCPs 410 and 510, respectively.

The backlight unit 340 includes lamps 341 disposed behind the display panel assembly 300, a spread plate 342 and optical sheets 343 disposed between the panel assembly 300 and the lamps 341. The spread plate 342 guides and diffuses light from the lamps 341 to the panel assembly 300. The backlight unit also includes a reflector 344 disposed under the lamps 341 and reflecting the light from the lamps 341 toward the panel assembly 300 and mold frames 345 and 363 maintaining the distance between the lamps 341 and the spread plate 342 and supporting the optical sheets 343.

The lamps 341 may include fluorescent lamps such as CCFL (cold cathode fluorescent lamp) and EEFL (external electrode fluorescent lamp). However, the lamps 341 may include light emitting diodes (LED), etc.

Referring to FIG. 2, the LCD also includes a gate driver 400 and a data driver 500 connected to the display panel assembly 300, a gray voltage generator 800 connected to the data driver 500, a lamp unit 940 including the lamps 341, an inverter 920 connected to the lamp unit 940, and a signal controller 600 controlling the above-described elements.

The inverter 920 includes an oscillator 921, a current controller 922 connected to the oscillator 921, a switching unit 923 connected to the current controller 922, a transformer 924 connected to the switching unit 923 and the lamp unit 940, a current sensor 925 connected to the lamp unit 940, and a temperature sensor 926 connected to the oscillator 921 and the current controller 922. The inverter 920 may be disposed on a stand-alone inverter PCB (not shown), or on the gate PCB 450 or the data PCB 550. The temperature sensor 926 may be separated from the inverter 920.

The display panel assembly 300 includes a lower panel 100, an upper panel 200, and a liquid crystal layer 3 interposed therebetween as shown in FIG. 3. The display panel assembly 300 it includes a plurality of display signal lines G1-Gn and D1-Dm and a plurality of pixels connected thereto and arranged substantially in a matrix in circuital view.

The display signal lines G1-Gn and D1-Dm are disposed on the lower panel 100 and include a plurality of gate lines G1-Gn transmitting gate signals (also referred to as “scanning signals”) and a plurality of data lines D1-Dm transmitting data signals. The gate lines G1-Gn extend substantially in a row direction and are substantially parallel to each other, while the data lines D1-Dm extend substantially in a column direction and are substantially parallel to each other.

Each pixel includes a switching element Q connected to the display signal lines G1-Gn and D1-Dm, and an LC capacitor C_{LC} and a storage capacitor C_{ST} that are connected to the switching element Q. The storage capacitor C_{ST} may be omitted if unnecessary.

The switching element Q that may be implemented as a TFT is disposed on the lower panel 100. The switching element Q has three terminals: a control terminal connected to one of the gate lines G1-Gn; an input terminal connected to one of the data lines D1-Dm; and an output terminal connected to the LC capacitor C_{LC} and the storage capacitor C_{ST}.

The LC capacitor C_{LC} includes a pixel electrode 190 provided on the lower panel 100 and a common electrode 270 provided on an upper panel 200 as two terminals. The LC layer 3 disposed between the two electrodes 190 and 270 functions as dielectric of the LC capacitor C_{LC}. The pixel electrode 190 is connected to the switching element Q, and the common electrode 270 is supplied with a common voltage Vcom and covers an entire surface of the upper panel 200. Unlike FIG. 2, the common electrode 270 may be provided on the lower panel 100, and both electrodes 190 and 270 may have shapes of bars or stripes.

The storage capacitor C_{ST} is an auxiliary capacitor for the LC capacitor C_{LC}. The storage capacitor C_{ST} includes the pixel electrode 190 and a separate signal line, which is provided on the lower panel 100, overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For color display, each pixel uniquely represents one of primary colors (i.e., spatial division) or each pixel sequentially represents the primary colors in turn (i.e., temporal division) such that spatial or temporal sum of the primary colors are recognized as a desired color. An example of a set of the primary colors includes red, green, and blue colors. FIG. 2 shows an example of the spatial division that each pixel includes a color filter 230 representing one of the primary colors in an area of the upper panel 200 facing the pixel electrode 190. Alternatively, the color filter 230 is provided on or under the pixel electrode 190 on the lower panel 100.

One or more polarizers (not shown) are attached to at least one of the panels 100 and 200.

Referring to FIGS. 1 and 2, the gray voltage generator 800 is disposed on the data PCB 550 and it generates two sets of gray voltages related to the transmittance of the pixels. The gray voltages in one set have a positive polarity with respect to the common voltage Vcom, while those in the other set have a negative polarity with respect to the common voltage Vcom.

The gate driver 400 includes a plurality of integrated circuit (IC) chips mounted on the respective gate TCPs 410. The gate driver 400 is connected to the gate lines G1-Gn of the panel assembly 300 and synthesizes the gate-on voltage Von and the gate off voltage Voff from an external device to generate gate signals for application to the gate lines G1-Gn.

The data driver 500 includes a plurality of IC chips mounted on the respective data TCPs 510. The data driver 500 is connected to the data lines D1-Dm of the panel assembly 300 and applies data voltages selected from the gray voltages supplied from the gray voltage generator 800 to the data lines D1-Dm.

According to another embodiment of the present invention, the IC chips of the gate driver 400 or the data driver 500 are mounted on the lower panel 100. According to further another embodiment, one or both of the drivers 400 and 500 are incorporated along with other elements into the lower panel 100. The gate PCB 450 and/or the gate TCPs 410 may be omitted in such embodiments.

The signal controller 600 controlling the drivers 400 and 500, etc. is disposed on the data PCB 550 or the gate PCB 450.

Now, the operation of the LCD will be described in detail with reference to FIGS. 1 to 3.

Referring to FIG. 1, the signal controller 600 is supplied with input image signals R, G and B and input control signals controlling the display thereof such as a vertical synchronization signal Vsync, a horizontal synchronization signal Hsync, a main clock MCLK, and a data enable signal DE, from an external graphics controller (not shown). After generating gate control signals CONT1 and data control signals CONT2 and processing the image signals R, G and B suitable for the operation of the panel assembly 300 on the basis of the input control signals and the input image signals R, G and B, the signal controller 600 provides the gate control signals CONT1 for the gate driver 400, and the processed image signals DAT and the data control signals CONT2 for the data driver 500.

The gate control signals CONT1 include a scanning start signal STV for instructing to start scanning and at least a clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing of start of data transmission for a group of pixels, a load signal LOAD for instructing to apply the data voltages to the data lines D₁-Dₘ, and a data clock signal HCLK. The data control signal CONT2 may further include an inversion signal RVS for reversing the polarity of the data voltages (with respect to the common voltage Vcom).

Responsive to the data control signals CONT2 from the signal controller 600, the data driver 500 receives a packet of the image data DAT for the group of pixels from the signal controller 600, converts the image data DAT into analog data voltages selected from the gray voltages supplied from the gray voltage generator 800, and applies the data voltages to the data lines D₁-Dₘ.

The gate driver 400 applies the gate-on voltage Von to the gate line G₁-Gₙ in response to the gate control signals CONT1 from the signal controller 600, thereby turning on the switching elements Q connected thereto. The data voltages applied to the data lines D₁-Dₘ are supplied to the pixels through the activated switching elements Q.

The difference between the data voltage and the common voltage Vcom applied to a pixel is expressed as a charged voltage of the LC capacitor C_{LC}, i.e., a pixel voltage. The liquid crystal molecules have orientations depending on the magnitude of the pixel voltage.

The inverter 920 converts a DC voltage from an external device into an AC voltage and boosts up the AC voltage and applies the boosted voltages to the lamp unit 940 to turn on/off the lamp unit 940, thereby controlling the luminance of the lamp unit 940.

In the meantime, the current sensor 925 detects the current flowing in the lamp unit 940 and the temperature sensor 926 detects the temperature near the lamp unit 940. The inverter 920 controls the voltage supplied to the lamp unit 940 based on the current information and the temperature information, which will be described later in detail.

The light from the lamp unit 940 passes through the LC layer 3 and experiences the change of its polarization. The change of the polarization is converted into that of the light transmittance by the polarizers.

By repeating this procedure by a unit of the horizontal period (which is denoted by “1H” and equal to one period of the horizontal synchronization signal Hsync and the data enable signal DE), all gate lines G₁-Gₙ are sequentially supplied with the gate-on voltage Von during a frame, thereby applying the data voltages to all pixels. When the next frame starts after finishing one frame, the inversion control signal RVS applied to the data driver 500 is controlled such that the polarity of the data voltages is reversed (which is referred to as “frame inversion”). The inversion control signal RVS may be also controlled such that the polarity of the data voltages flowing in a data line in one frame are reversed (for example, line inversion and dot inversion), or the polarity of the data voltages in one packet are reversed (for example, column inversion and dot inversion).

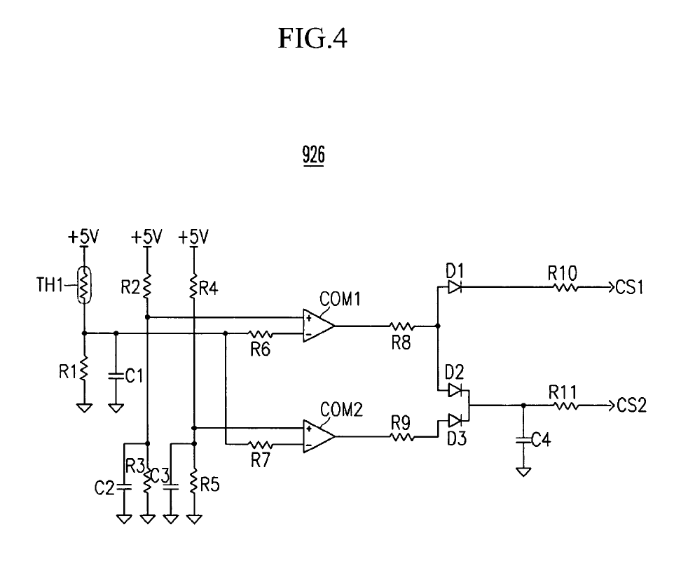

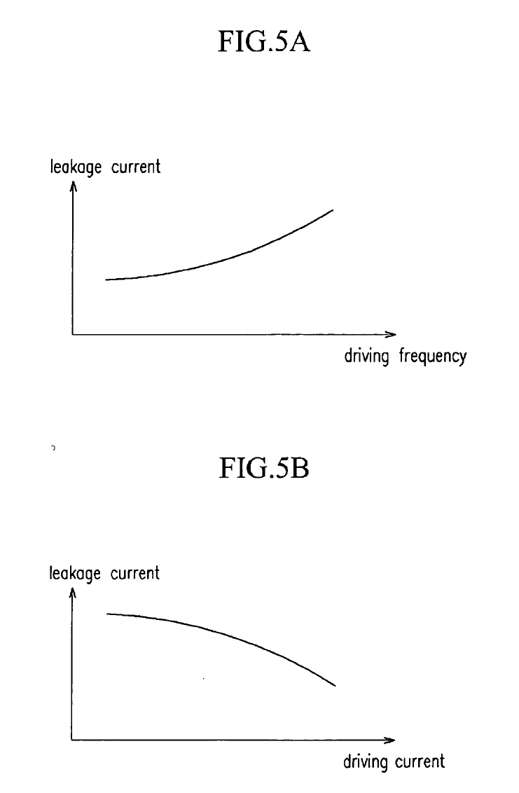

Now, an inverter according to an embodiment of the present invention will be described in detail with reference to FIGS. 4, 5A and 5B.

FIG. 4 is a circuit diagram of a temperature sensor according to an embodiment of the present invention, and FIGS. 5A and 5B are graphs illustrating current leakage as function of a driving frequency and a driving current, respectively.

Referring to FIG. 4, a temperature sensor 926 according to this embodiment includes a temperature sensing unit including a temperature sensing element TH1, a comparing unit including a pair of comparators COM1 and COM2 and connected to the temperature sensing unit, and a signal addition and division unit including three diodes D1-D3 and connected to the comparing unit, and a low pass filter including a resistor R11 and a capacitor C4 and connected to the current addition and dividing unit.

The temperature sensing unit further includes a resistor R1 and a capacitor C1 connected in parallel between the temperature sensing element TH1 and a ground as well as the temperature sensing element TH1 connected to a supply voltage (illustrated as +5 V in FIG. 4). The temperature sensing element TH1 may include a thermistor that have a resistance varying depending on the temperature, preferably increasing as the temperature decreases. The temperature sensing element TH1 may be disposed near the backlight unit 340, the lamp unit 940, or the inverter 920. However, the characteristics and the mounting position of the thermistor TH1 may be varied.

The comparing unit further includes two voltage dividing filters for supplying reference voltages to the comparators COM1 and COM2. Each voltage dividing filter includes a pair of resistors (R2 and R3)/(R4 and R5) connected in series between the supply voltage and the ground and a capacitor C2/C3 connected in parallel to the grounded resistor R3/R5. Outputs of the voltage dividing filters are preferably different.

Each of the comparators COM1 and COM2 has a non-inverting terminal (+) connected to one of the voltage dividers, an inverting terminal (−) connected to the temperature sensing unit via an input resistor R6 or R7, and an output terminal provided with an output resistor R8 or R9. The comparator COM1 or COM2 generates a bistate output signal exhibiting two states depending on the relative magnitudes of two inputs. For example, the output signal of the comparator COM1 or COM2 is in a high state when an inverting input is lower than a non-inverting input and in a low state when the inverting input is higher than the non-inverting input. Then, the outputs of the comparators COM1 and COM2 form three combinations since the non-inverting inputs thereof are different.

The three combinations indicate the respective ranges of the temperature and it is possible to make the combinations indicate desired temperature ranges by adjusting the resistances R3-R8. For example, both the outputs of the comparators COM1 and COM2 are in the low states when a peripheral temperature is higher than a first predetermined value, which indicate that the lamp unit 940 is in a normal condition, the outputs of the comparators COM1 and COM2 are in the high and the low states, respectively, when the peripheral temperature ranges from a second predetermined value to the first predetermined value, and both the outputs of the comparators COM1 and COM2 are in the high states when the peripheral temperature is lower than the second predetermined value, which indicate that the lamp unit 940 hardly perform a normal operation. The first and the second values may be about 5° C. and about −10° C., respectively. However, the first and the second values can be determined depending on the characteristics of the lamp unit 940 and peripheral conditions.

The three diodes D1-D3 of the signal addition and division unit direct in forward direction from the comparing unit to output terminals of the temperature sensor 926. The diodes D1 and D2 are connected to the output terminal of the comparator COM1 and the diode D3 is connected to the output terminal of the comparator COM2. The output of the diode D1 forms one output of the temperature sensor 926 through a resistor R10, which is supplied to the oscillator 621, and the outputs of the diodes D2 and D3 are commonly connected to the low pass filter that has an output serving as another output of the temperature sensor 926, which is supplied to the current controller 622.

Now, the operation of the inverter 920 including the temperature sensor 926 shown in FIGS. 4-5B will be described in detail.

The oscillator 921 generates a carrier signal having a triangular or sawtooth waveform and a predetermined frequency and outputs the carrier signal to the current controller 922 for igniting the lamp unit 940. The current controller 922 pulse-width-modulates a reference signal (not shown) based on the carrier signal to generate a PWM (pulse width modulation) signal.

The switching unit 923 converts the PWM signal into an AC voltage and supplies the AC voltage to the transformer 924. The transformer 924 boosts up the AC voltage and applied the boosted AC voltage to the lamp unit 940 to light on the lamp unit 940. The AC voltage may be applied to both ends of each lamp 341 in the lamp unit 940, that is, the two ends of each lamp 341 are subjected to periodically varying voltages having opposite phases. In this case, a midpoint of the lamp 341 may have a grounded voltage.

During the operation of the lamp unit 940, the current sensor 925 detects the current flowing in the lamp unit 940 and feeds it back to the current controller 922 and the current controller 922 controls the PWM signal based on the current information supplied from the current sensor 925 so that the current flowing in the lamp unit 940 may be uniform.

In the meantime, the temperature sensing element TH1 varies its resistance depending on the temperature and the temperature sensing unit TH1, R1 and C1 outputs a voltage having a magnitude depending on the sensed temperature. In detail, the output voltage of the temperature sensing unit TH1, R1 and C1 decreases as the sensed temperature increases.

The comparators COM1 and COM2 compare the output voltage of the temperature sensing unit TH1, R1 and C1 with the reference voltages supplied from the voltage dividers and generates output signals depending on the output voltage of the temperature sensing unit TH1, R1 and C1.

The output signal of the comparator COM1 is bifurcated and one bifurcation of the output signal of the comparator COM1 is outputted via the diode D1 and the resistor R10 to be transmitted to the oscillator 921 as a frequency control signal SC1, while the other bifurcation of the output signal passes through the diode D2. The output signal of the comparator COM2 passes through the diode D3 and joins the signal outputted from the diode D2 such that it is outputted via the low pass filter R11 and C4 to be supplied to the current controller 922 as a current control signal SC2.

The oscillator 921 adjusts the frequency of the carrier signal in response to the frequency control signal SC1, and the current controller 922 adjusts the PWM signal or the reference signal for generating the PWM signal in response to the current control signal SC2.

In detail, when both the frequency control signal SC1 and the current control signal SC2 inform that the lamp unit 940 operates in a normal state, for example, when both the frequency control signal SC1 and the current control signal SC2 are in low states, the oscillator 921 and the current controller 922 maintain their operations. However, when at least one of the frequency control signal SC1 and the current control signal SC2 informs of abnormal operation of the lamp unit 940, for example, when the frequency control signal SC1 is in the high state and the current control signal SC2 is in the low state, or when both the frequency control signal SC1 and the current control signal SC2 are in the high states, the oscillator 921 and the current controller 922 operate so that the driving frequency of the lamp unit 940 may be reduced and the driving current of the lamp unit 940 may be increased.

It is because the current leakage in the lamp unit 940 increases as the peripheral temperature decreases because of the decreased impedance of the lamp unit 940 under the low temperature, and, in addition, the current leakage decreases as the driving frequency decreases and the driving current increases as shown in FIGS. 5A and 5B.

Since the latter case (i.e., SC1=high and SC2=high) indicates an abnormal state worse than the former case (i.e., SC1=high and SC2=low), the variations of the frequency and the current for the latter case may be larger than those for the former case.

For example, the oscillator 921 reduces the frequency of carrier signal and the current controller 922 increases the amplitude of the PWM signal and the resultant PWM signal outputted from the current controller 922 has a reduced frequency and an increased amplitude. Accordingly, the driving current for the lamp unit 940 can also have a reduced frequency and an increased amplitude to reduce the current leakage, thereby increasing the luminance of the lamp unit 940.

As a result, the device according to the embodiment of the present invention can compensate the increased current leakage of the lamp unit 940 under the low temperature by adjusting the driving frequency and the driving current of the lamp unit 940 depending on the peripheral temperature. Accordingly, the luminance of the lamp unit 940 can be uniformly maintained to prevent the deterioration of the image quality of the LCD.

Only one of the driving frequency and the driving current may be adjusted depending on the temperature and, in this case, one of the comparators COM1 and COM2 may be omitted.

The above described configurations are adaptable to any kind of display device including a light source.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

1. A device of driving a light source for a display device, the device comprising:
a temperature sensor detecting a temperature near the light source; and
an inverter controlling the light source depending on temperature information supplied from the temperature sensor.

2. The device of claim 1, wherein the inverter adjusts a driving frequency or a driving current of the light source depending on the temperature information.

3. The device of claim 2, wherein the inverter adjusts the driving frequency and the driving current of the light source depending on the temperature information.

4. The device of claim 3, wherein the inverter decreases the driving frequency when the detected temperature is lower than a first temperature.

5. The device of claim 4, wherein the inverter increases the driving current when the detected temperature is lower than a second temperature lower than the first temperature.

6. The device of claim 2, wherein the light source comprises a lamp having two opposite ends supplied with AC voltage.

7. The device of claim 1, wherein the temperature sensor comprises:
a temperature sensing unit outputting a voltage having a magnitude varying dependent on a peripheral temperature; and
a first comparator comparing the output voltage of the temperature sensing unit with a first reference voltage to generate a first comparison signal.

8. The device of claim 7, wherein the temperature sensor further comprises:
a second comparator comparing the output voltage of the temperature sensing unit with a second reference voltage different from the first reference voltage to generate a second comparison signal.

9. The device of claim 8, wherein the temperature sensor further comprises:
a signal addition and division unit dividing the first comparison signal to generate a first output signal and adding the first comparison signal and the second comparison signal to generate a second output signal, the first and the second output signal being provided as the temperature information for the inverter.

10. The device of claim 9, wherein the signal addition and division unit temperature sensor comprises:
a first diode connected to the first comparator and having an output for the first output signal;
a second diode connected to the first comparator in parallel to the first diode; and
a third diode connected to the second comparator,
wherein the second and the third diode have a common output for the second output signal.

11. The device of claim 9, wherein the inverter comprises:
a signal generator generating a periodical signal having a frequency that varies depending on the first output signal supplied from the temperature sensor;
a controller generating a DC driving signal based on the periodical signal supplied from the signal generator and the second output signal supplied from the temperature sensor;
a switching unit converting the DC driving signal into an AC driving signal; and
a transformer boosting up the AC driving signal and applying the boosted AC signal to the light source.

12. The device of claim 11, further comprising:
a current sensor detecting a current flowing in the light source and supplying current information to the controller,
wherein the controller adjusts the DC driving signal based on the current information.

13. The device of claim 1, wherein the inverter comprises:
a signal generator generating a periodical signal having a frequency that varies depending on the temperature information;
a controller generating a DC driving signal based on the periodical signal supplied from the signal generator and the temperature information;
a switching unit converting the DC driving signal into an AC driving signal; and
a transformer boosting up the AC driving signal and applying the boosted AC signal to the light source.

14. The device of claim 13, wherein the signal generator decreases the frequency of the periodical signal when the temperature information indicates that the detected temperatures is lower than a first temperature.

15. The device of claim 14, wherein the controller increases the amplitude of the DC driving signal when the temperature information indicates that the detected temperatures is lower than a second temperature lower than the first temperature.

16. The device of claim 13, further comprising:
a current sensor detecting a current flowing in the light source and supplying current information to the controller,
wherein the controller adjusts the DC driving signal based on the current information.

17. A display device comprising:
a display panel displaying images;
a lamp supplying light to the display panel;
a temperature sensor detecting a temperature near the lamp; and
an inverter controlling the light source depending on temperature information supplied from the temperature sensor.

18. The display device of claim 17, wherein the inverter decreases the driving frequency when the detected temperature is lower than a first temperature and increases the driving current when the detected temperature is lower than a second temperature lower than the first temperature.

19. The display device of claim 17, wherein the temperature sensor comprises:
a temperature sensing unit outputting a voltage having a magnitude varying dependent on a peripheral temperature;
a first comparator comparing the output voltage of the temperature sensing unit with a first reference voltage to generate a first comparison signal;
a second comparator comparing the output voltage of the temperature sensing unit with a second reference voltage different from the first reference voltage to generate a second comparison signal; and
a signal addition and division unit dividing the first comparison signal to generate a first output signal and adding the first comparison signal and the second comparison signal to generate a second output signal, the first and the second output signal being provided as the temperature information for the inverter.

20. The display device of claim 19, wherein the inverter comprises:
a signal generator generating a periodical signal having a frequency that varies depending on the first output signal supplied from the temperature sensor;
a controller generating a DC driving signal based on the periodical signal supplied from the signal generator and the second output signal supplied from the temperature sensor;
a switching unit converting the DC driving signal into an AC driving signal; and
a transformer boosting up the AC driving signal and applying the boosted AC signal to the lamp.
